(19) United States
(12) Patent Application Publication
(10) Pub. No.: US 2008/0248318 A1
(43) Pub. Date: Oct. 9, 2008

(54) Low-Opacity Release Paper, Release-Paper Backing and Methods

(75) Inventors: Daniel G. Fry, West Linn, OR (US); Matthew F. Wannamaker, Brush Prairie, WA (US); Jennifer Lien, International Falls, MN (US); Frank Edwards, International Falls, MN (US); Bruce Hupp, Naperville, IL (US)

Correspondence Address: KLARQUIST SPARKMAN, LLP, 121 SW SALMON STREET, SUITE 1600, PORTLAND, OR, 97204, US

(73) Assignee: BOISE WHITE PAPER, L.L.C., BOISE, ID (US)

(21) Appl. No.: 10/593,671

(22) PCT Filed: Aug. 25, 2005
(86) PCT No.: PCT/US2005/030433

§ 371 Date: Sep. 20, 2006

(51) Int. Cl. B32B 29/00; B05D 3/12

(52) U.S. Cl. 428/454; 427/361; 427/364

(57) ABSTRACT

Release papers and release paper backings (10) are disclosed. The release papers and release paper backings (10) can include a network of fibers (12) and yellow and/or red dye and a first coating (14) on a first surface (16). Light transmission through the release paper and release-paper backings (10) can be, for example, between about 40% and about 80% at a wavelength of about 680 nm. The Gurley density can be, for example, between about 4,000 seconds and about 10,000 seconds. The release papers and release paper backings (10) also can have a positive b* value on the International Commission on Illumination L*a*b* scale. Overall, the release papers and release paper backings (10) can have a greater ability to transmit light when compared with conventional release papers and release paper backings at some or all wavelengths in the visible spectrum.

### FIELD

This disclosure concerns release papers, release-paper backings and associated methods, particularly with regard to release papers and release-paper backings having enhanced optical characteristics well suited for use with light sensors, such as LED (light emitting diode) sensors.

### BACKGROUND

Release paper typically is used to temporarily hold flat objects, such as labels, that need to be readily detachable. Often, the objects held by release paper have an adhesive coating and the release paper helps to protect the adhesive coating from degradation before the object is ready for use. For example, labels can be stored, shipped and processed through label application machinery with their adhesive sides in contact with sheets of release paper.

Most forms of release paper include a release-paper backing coated with a release coating. The release coating can contain lubricants, such as silicone, that are resistant to bonding. When contacted with an adhesive, some bonding will occur, but the adhesive will remain intact. The limited bonding allows objects to be held in place before they are ready for use.

For a variety of applications, including label dispensing applications, it is necessary to automatically sense the position of an object on a sheet of release paper. This typically is done with a LED sensor, such as a through-beam LED sensor. Through-beam LED sensors detect the position of an object by shining a beam of light from an emitter to a receiver and measuring changes in the light hitting the receiver. Objects passing between the emitter and the receiver temporarily block or otherwise change the light received by the receiver. This change is detected by the receiver, triggering the receiver to send a signal indicating the presence of an object Through-beam LED sensors rely on contrast, which is the ratio of the intensity of light received by the receiver in the light condition (i.e., when only the release paper is in the path of the beam) to the intensity of light received by the receiver in the dark condition (i.e., when both the release paper and the object to be detected are in the path of the beam). To achieve high contrast, there must be significantly greater light transmission in the light condition than in the dark condition. Increased light transmission in the light condition can be achieved by increasing light transmission though the release paper.

It is known that air voids interfere with light transmission through paper. Paper products with few air voids, such as high-density paper products, tend to have greater light transmission. Some high-density paper products, such as glassine paper and supercalendered kraft paper, have been used in release paper. High-density paper products typically are made by supercalendering processes in which the paper is pressed between rollers at very high pressures. Supercalendering equipment, however, is not available in many papermaking facilities. When used, supercalendering typically is performed off-line. As a result of their processing requirements, high-density paper products are particularly expensive to manufacture.

### SUMMARY

Disclosed herein are embodiments of release papers and release-paper backings. Also disclosed are embodiments of methods for making the disclosed release papers and release-paper backings. Release-paper backings can be distinguished from release papers in that they do not include a release coating, such as a silicone release coating. Release-paper backings, however, typically have a major surface configured to support a release coating. Release-paper backings can be combined with release coatings to form release papers.

The disclosed release papers and release-paper backings can include a network of fibers and a dye, such as a dye configured to increase the ability of the release paper or release-paper backing to transmit light. The dye can be, for example, a yellow and/or red dye. In some of these embodiments, the dye is distributed throughout the network of fibers. The desired increase in transmittance also might be obtained by adding other ingredients or components to the release paper or release-paper backing. For example, it may be possible to add one or more sheets of material, such as one or more sheets of a translucent material with a particular color scheme and/or pattern configured to increase transmittance.

Embodiments of the disclosed release papers and release-paper backings can have increased light transmission at particular ranges of wavelengths, such as the ranges emitted by red, green, blue or white LEDs or combinations thereof. For example, some of the disclosed embodiments have a light transmission between about 40% and about 80% or between about 50% and about 80% at a wavelength of about 680 nm, which is characteristic of a red LED. These and other embodiments can have a Gurley density between about 4,000 seconds and about 10,000 seconds, such as between about 4,000 seconds and about 8,000 seconds. On the International Commission on Illumination L*a*b* scale, the disclosed release paper and release-paper backing embodiments can have a positive b* value, such as a b* value between about +6 and about +20.

The network of fibers can be within a core sheet that is coated on one or both of its major surfaces. For example, the disclosed release-paper backings can include a first coating on a first major surface of the core sheet and a second coating on a second major surface of the core sheet, with the first coating configured to support the release coating. The first coating can include clay, such as between about 60% and about 80% clay. The first coating also can include starch, starch-like material, latex or a combination thereof. In some disclosed embodiments, the first coating includes a starch or starch-like material and a crosslinking agent. The second coating also can include a starch or starch-like material, which can, for example, substantially penetrate the core sheet to increase the ability of the overall release-paper backing or release paper to transmit light.

Some of the disclosed methods are directed to making a release paper or release-paper backing configured for use with a particular type of light-actuated position detecting sensor having a light source. These methods can include selecting a type of sensor to be used with the release paper or release-paper backing and evaluating light transmission through the release paper or release-paper backing for the light source of the selected type of sensor. These methods also can include modifying the release paper or release-paper backing to increase light transmission, thereby increasing contrast and improving performance during optical detection operations. In some embodiments, the release paper or release-paper backing is modified by selecting a dye based on the effect of the dye on light transmission through the release paper or release-paper backing at wavelengths emitted by the light source and incorporating the dye into at least a portion of the release paper or release-paper backing. The light source can, for example, be a red LED and the dye can, for example, be a yellow dye, a red dye or a combination thereof.

The disclosed methods for making release papers and release-paper backings can include forming a mixture including a paper stock and a dye selected to increase the light transmission of the release paper or release-paper backing at a wavelength range generated by a red LED, a green LED, a blue LED, a white LED or a combination thereof. The dye, for example, can be a yellow dye, a red dye or a combination thereof. The mixture can be formed into a sheet with a first major surface onto which a first coating is applied. The sheet also can be hot-soft calendered. To make release paper, a release coating can be applied over the first coating. Embodiments of these methods also can include applying a second coating on a second major surface of the sheet. The second coating can include a starch or starch-like material that substantially penetrates into the sheet. The hot-soft calendering step, for example, can include calendering at a pressure between about 500 pli and about 2,000 pli and/or calendering to achieve a Gurley density between about 4,000 seconds and about 10,000 seconds.

Also disclosed are methods for improving the transmittance of release papers and release-paper backings in optical sensing operations. For example, these methods can include modifying release papers or release-paper backings to decrease the amount of sensing light absorbed and/or reflected by the release papers or release-paper backings. Some of the disclosed methods include, for example, incorporating a dye configured to increase an ability of the release paper or release-paper backing to transmit light. The dye can have a dye color selected based, at least in part, on a color of light to which the release paper or release-paper backing is subjected during optical detection operations.

### BRIEF DESCRIPTION OF THE DRAWINGS

FIG. 1 is a cross-sectional schematic view of a release-paper backing embodiment comprising a core sheet and a first coating.

FIG. 2 is a cross-sectional schematic view of a release-paper backing embodiment comprising a core sheet, a first coating and a second coating.

FIG. 3 is a cross-sectional schematic view of a release paper embodiment comprising the release-paper backing shown in FIG. 2 and a release coating.

FIG. 4 is a graph showing the percent light transmission at different wavelengths in the visible spectrum for a conventional release-paper backing and three embodiments of the disclosed release-paper backing with increasing concentrations of yellow dye.

FIG. 5 is a graph showing the percent light transmission at different wavelengths in the visible spectrum for four handsheets dyed yellow, red, green and blue, respectively.

FIG. 6 is a graph showing the ratio of absorption to scattering at different wavelengths in the visible spectrum for four handsheets dyed yellow, red, green and blue, respectively.

### DETAILED DESCRIPTION

The following terms may be abbreviated in this disclosure: absorption (K), cubic centimeter (cc), light emitting diode (LED), lightweight release liner (LWRL), micrometer (μm), nanometer (nm), parker print surf (PPS), pound (lb), pounds per linear inch (pli), scattering (S), square feet (ft²), supercalendered kraft paper (SCK) and Technical Association of the Pulp and Paper Industry (TAPPI).

Unless otherwise explained, all technical and scientific terms used herein have the same meaning as commonly understood by one of ordinary skill in the art to which this disclosure belongs. The singular terms “a,” “an,” and “the” include plural referents unless context clearly indicates otherwise. Similarly, the word “or” is intended to include “and” unless the context clearly indicates otherwise. The term “includes” means “comprises.” All coating weights recited herein are dry coating weights unless indicated otherwise. Similarly, the percentages of various components in the coatings are dry weight percents unless indicated otherwise.

Disclosed herein are embodiments of release papers and release-paper backings. Also disclosed are embodiments of methods for making and using release papers and release-paper backings. In general, the disclosed release papers and release-paper backings are designed for use in settings where optical detection or sensing takes place, such as, for example, where a LED sensor, or another type of light source, is positioned to direct energy at a release paper or release-paper backing.

For acceptable reliability, many LED sensors require a contrast ratio of at least about 3:1. Thus, in some implementations, the amount of light transmitted through the release paper alone must be significantly greater, such as at least about three times greater, than the amount of light transmitted though the combination of the release paper and the object to be detected, which can be, for example, a label. The disclosed release papers and release-paper backings generally are designed to have an increased ability to transmit light, which increases the contrast detected by the LED sensor between the light and dark conditions.

Red LEDs, which are widely available and inexpensive, are the most common light sources in the LED sensors used for label detection and other applications involving release paper. Typical red LED light sources emit light at wavelengths primarily in the range of about 660 nm to about 700 nm. Other potentially useful light sources include infrared, red, green, blue and white LEDs and combinations thereof. Some embodiments of the disclosed release papers and release-paper backings are specifically designed to have improved light transmission at wavelengths generated by particular LED sensor light sources. For example, some embodiments are designed to have improved light transmission at wavelengths generated by infrared, red, green, blue or white LED light sources or combinations thereof.

Many of the disclosed components and processing steps generally improve the light transmission of the release papers and release-paper backings over a broad range of wavelengths. Other components and processing steps have a greater effect at some wavelengths than at other wavelengths. Because red LEDs are the most commonly used light sources in LED sensors, some of the disclosed components and processing steps are specifically designed to increase the light transmission at the wavelengths emitted by red LEDs, such as wavelengths in the range of about 660 nm to about 700 nm. Of course, the concepts disclosed herein can be extended to increase light transmission at other wavelengths as well, including those emitted by other types of LEDs, such as infrared, green, blue or white LEDs or combinations thereof.

Structure and Components of the Release-Papers and Release-Paper Backings

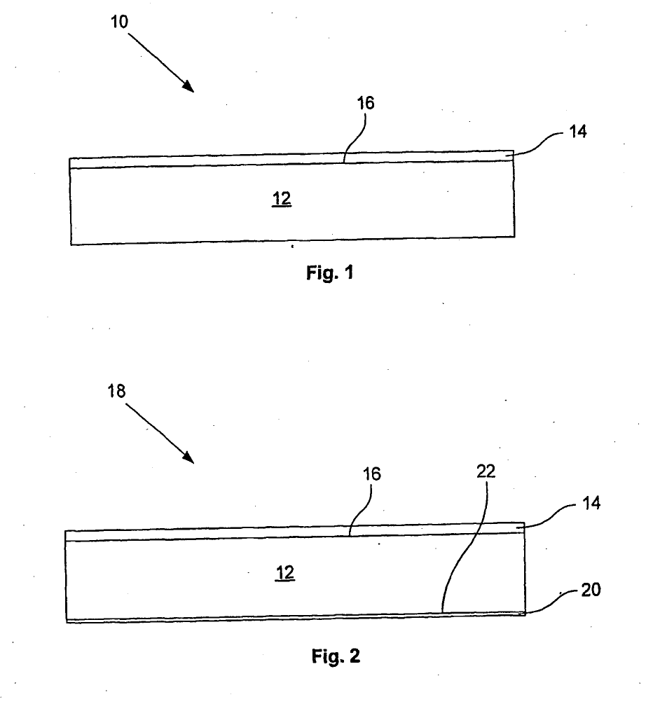

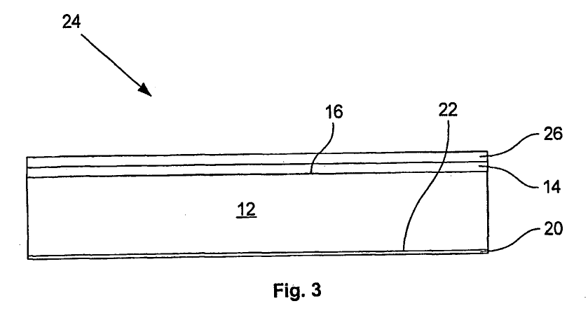

FIG. 1 is a cross-sectional schematic view of one embodiment of a disclosed release-paper backing 10, including a core sheet 12 with a first coating 14 on a first major surface 16. FIG. 2 is a cross-sectional schematic view of one embodiment of a disclosed release-paper backing 18, including a core sheet 12, a first coating 14 on a first major surface 16 and a second coating 20 on a second major surface 22. The second major surface 22 is opposite to the first major surface 16. FIG. 3 is a cross-sectional schematic view of one embodiment of a disclosed release paper 24, including the release-paper backing 18 illustrated in FIG. 2 and a release coating 26 over the first coating 14. FIGS. 1-3 are not drawn to scale.

### Core Sheet

The core sheet generally provides structural integrity to the release-paper backing. The core sheet can include a network of fibers, such as cellulose fibers derived from wood pulp. For example, the core sheet can be made from bleached chemical pulps from the kraft pulping process, including hardwood fiber types, softwood fiber types, or both. Of course, other types of core sheets also can be used.

### First Coating

The first coating can function as a base for the release coating. In many of the disclosed embodiments, the first coating promotes holdout, which is the degree to which the release-paper backing resists penetration of the release coating. For most applications, the preferred release coating is a silicone release coating. When applied over a first coating with good holdout, less silicone is needed to form a uniform release coating. Silicone is an expensive material, so reducing the amount of silicone required to form the release coating significantly decreases the overall cost of the product. In some of the disclosed release-paper backing embodiments, the first coating has good holdout with respect to both hydrophilic and hydrophobic solutions. This is useful because silicone coatings can be applied with either aqueous or organic solvents.

The coating weight of the first coating can be, for example, a coating weight sufficient to substantially improve the holdout of the release-paper backing. This can range, for example, from about 5.0 lbs/3000 ft² (263 lbs/ton) to about 8.5 lbs/3000 ft² (442 lbs/ton), such as from about 5.5 lbs/3000 ft² (289 lbs/ton) to about 7.5 lbs/3000 ft² (395 lbs/ton) or from about 6.0 lbs/3000 ft² (316 lbs/ton) to about 6.5 lbs/3000 ft² (347 lbs/ton).

The first coating can include clay, such as kaolin clay, as a major component The clay typically covers the underlying fibers of the core sheet so as to prevent the release coating from contacting these fibers. This improves the holdout of the release-paper backing. Useful types of clay can be differentiated by particle size. For example, coating clay, such as No. 1 or No. 2 coating clay, typically has a particle size distribution with about 80% of the particles having a diameter less than 2 μm, while coarse delaminated clay typically has a particle size distribution with about 60% of the particles having a diameter less than 2 μm. Course delaminated clay typically is more effective at covering the fibers of the core sheet than coating clay. Coating clay, however, has greater runnability on coating machines than course delaminated clay. Some disclosed embodiments include a combination of coating clay and coarse delaminated clay. The ratio of coating clay to coarse delaminated clay can vary, for example, from about 40:60 to about 80:20, such as from about 60:40 to about 70:30 or from about 65:35 to about 75:25.

In some disclosed embodiments, the first coating includes a percentage of clay and/or a coating weight of clay sufficient to substantially coat the fibers of the core sheet on the first major surface. For example, the first coating can include between about 60% and about 80% clay, such as between about 70% and about 80% clay or between about 74% and about 78% clay. The coating weight of the clay can be, for example, between about 3.9 lbs/3000 ft² (205 lbs/ton) and about 5.3 lbs/3000 ft² (279 lbs/ton), such as between about 4.6 lbs/3000 ft² (242 lbs/ton) and about 5.3 lbs/3000 ft² (279 lbs/ton) or between about 4.9 lbs/3000 ft² (258 lbs/ton) and about 5.1 lbs/3000 ft² (268 lbs/ton).

In addition to clay, the first coating can include a starch or starch-like material. These materials are film-forming agents that also improve holdout. High molecular weight starches and starch-like materials generally have greater film-forming capabilities than low molecular weight starches and starch-like materials. Suitable types of starch and starch-like materials include modified potato starch, modified corn starch, polyvinyl alcohol, carboxymethylated cellulose, and combinations thereof. Useful starches and starch-like materials can have an alkali fluidity number, for example, between about 40 cc and about 80 cc, such as between about 55 cc and about 80 cc or between about 60 cc and about 80 cc.

In some disclosed embodiments, the first coating includes a percentage of starch or starch-like material and/or a coating weight of starch or starch-like material sufficient to form a network that improves holdout. For example, the first coating can include a percentage of starch or starch-like material between about 2.0% and about 6.0%, such as between about 3.0% and about 5.0% or between about 3.5% and about 4.0%. The coating weight of the starch or starch-like material can be, for example, between about 0.13 lbs/3000 ft² (6.9 lbs/ton) and about 0.40 lbs/3000 ft² (21.0 lbs/ton), such as between about 0.20 lbs/3000 ft² (10.5 lbs/ton) and about 0.33 lbs/3000 ft² (17.4 lbs/ton) or between about 0.23 lbs/3000 ft² (12.1 lbs/ton) and about 0.26 lbs/3000 ft² (13.9 lbs/ton).

The first coating also can include latex. Like starch and starch-like materials, latex is a film-forming agent that improves holdout. Carboxylated styrene butadiene polymer is one example of a suitable type of latex.

In some disclosed embodiments, the first coating includes a percentage of latex and/or a coating weight of latex sufficient to form a network that improves holdout. For example, the first coating can include between about 15% and about 25% latex, such as between about 17% and about 22% latex or between about 18% and about 20% latex. The coating weight of the latex can be, for example, between about 1.0 lbs/3000 ft² (52.6 lbs/ton) and about 1.7 lbs/3000 ft² (89.5 lbs/ton), such as between about 1.1 lbs/3000 ft² (57.9 lbs/ton) and about 1.5 lbs/3000 ft² (78.9 lbs/ton) or between about 1.2 lbs/3000 ft² (63.2 lbs/ton) and about 1.3 lbs/3000 ft² (68.4 lbs/ton).

The first coating also can include a crosslinking agent. The cross-linking agent can serve to insolubilize the starch or starch-like material so that it does not become rewetted during subsequent processing. Modified glyoxal resin is one example of a suitable type of crosslinking agent.

In some disclosed embodiments, the first coating includes a percentage of crosslinking agent and/or a coating weight of crosslinking agent sufficient to substantially insolubilize the starch or starch-like material. For example, the first coating can include between about 0.5% and about 1.5% crosslinking agent, such as between about 0.6% and about 1.2% crosslinling agent or between about 0.75% and about 1.0% crosslinking agent. The coating weight of the crosslinking agent can be, for example, between about 0.03 lbs/3000 ft² (1.6 lbs/ton) and about 0.10 lbs/3000 ft² (5.3 lbs/ton), such as between about 0.04 lbs/3000 ft² (2.1 lbs/ton) and about 0.08 lbs/3000 ft² (4.2 lbs/ton) or between about 0.05 lbs/3000 ft² (2.6 lbs/ton) and about 0.07 lbs/3000 ft² (3.7 lbs/ton).

### Release Coating

A release coating can be applied to the disclosed release-paper backings to form release paper. The release-paper backings can be manufactured and sold with or without the release coating. In some implementations, the release-paper backings are manufactured and sold by a first entity and purchased by a second entity. The second entity then applies the release coating and sells the overall release paper to the end user.

The release coating typically includes silicone as a major ingredient. Silicone release coatings can be applied, for example, by a crosslinking process. Some silicones can be crosslinked by performing a condensation reaction in the presence of a catalyst. Additional detail regarding the release coating can be found, for example, in U.S. Pat. No. 6,008,310, which is incorporated herein by reference. Experiments have shown that the release coating has little or no effect on the ability of the release paper to transmit light

### Second Coating

Some embodiments of the disclosed release papers and release-paper backings include a second coating on a second major surface of the core sheet The second coating can serve to prevent curling and improve light transmission.

The overall coating weight of the second coating can range, for example, from about 0.5 lbs/3000 ft² (26.3 lbs/ton) to about 3.5 lbs/3000 ft² (184.2 lbs/ton), such as from about 0.5 lbs/3000 ft² (39.5 lbs/ton) to about 2.0 lbs/3000 ft² (105.3 lbs/ton) or from about 0.75 lbs/3000 ft² (26.3 lbs/ton) to about 1.5 lbs/3000 ft² (79.0 lbs/ton).

The second coating can include a starch or starch-like material as a major component. Suitable types of starch and starch-like materials for incorporation into the second coating include ethylated corn starch, oxidized corn starch, ammonium persulfate converted corn starch, enzyme converted corn starch, and combinations thereof. The starch or starch-like material can be applied, for example, at between about 5% and about 30% solids, such as between about 10% and about 25% solids or between about 18% and about 22% solids.

Low molecular weight starches and starch-like materials generally are preferred for incorporation into the second coating, such as starches and starch-like materials with alkali fluidity numbers between about 30 cc and about 80 cc, such as between about 40 cc and about 60 cc or between about 45 cc and about 55 cc. Starches and starch-like materials with high alkali fluidity numbers generally have lower viscosities than starches and starch-like materials with low alkali fluidity numbers. This low viscosity allows these materials to substantially penetrate into the core sheet and fill some of the air voids in the core sheet. Filling these air voids generally reduces scattering and increases light transmission.

In some disclosed embodiments, the second coating includes a percentage of starch or starch-like material and/or a coating weight of starch or starch-like material sufficient to substantially prevent curling and/or substantially penetrate into the core sheet. For example, the second coating can include a percentage of starch or starch-like material between about 20% and about 80%, such as between about 45% and about 65% or between about 50% and about 60%. The coating weight of the starch or starch-like material can be, for example, between about 0.2 lbs/3000 (10.5 lbs/ton) and about 0.8 lbs/3000 ft² (42 lbs/ton), such as between about 0.45 lbs/3000 ft² (23.6 lbs/ton) and about 0.65 lbs/3000 ft² (34 lbs/ton) or between about 0.5 lbs/3000 ft² (26.3 lbs/ton) and about 0.6 lbs/3000 ft² (31.6 lbs/ton).

### Dye

The disclosed release papers and release-paper backings also can include a dye. The dye can be incorporated into various portions of the release papers and release-paper backings. In some embodiments, the dye is incorporated into the core sheet. For example, the dye can be intermixed with a network of fibers to provide a product with a substantially even color.

It has been discovered that dye improves the ability of the disclosed release papers and release-paper backings to transmit light emitted by LED sensors. Different dyes have been found to affect light transmission at different wavelengths. For example, yellow dye and, to a lesser extent, red dye have been found to improve light transmission at wavelengths emitted by red LED sensors. Therefore, embodiments intended for use with red LED sensors can be dyed with yellow dye, red dye or a combination thereof. Embodiments intended for use with sensors incorporating other light sources can be dyed with the appropriate dye for increasing light transmission at the wavelengths emitted by these light sources. In embodiments that include yellow dye within the core sheet, the yellow dye can be present, for example, at between about 1.0 ounce per ton and about 6.5 ounces per ton, such as between about 1.8 ounces per ton and about 6.5 ounce per ton.

### Making the Release-Papers and Release-Paper Backings

The process of making the disclosed release papers and release-paper backings can include forming the core sheet, applying the first and second coatings and hot soft-calendering the overall product. These steps all can be performed using conventional papermaking equipment. For example, the core can be formed by a continuous process using a Fourdrinier paper machine or with a twin wire forming section. Fourdrinier paper machines include a “wet end” at which the pulp is mixed before being deposited on a screen, pressed and dried. The dye can be added at the wet end, prior to the sheet forming section of the paper machine. This generally promotes uniform incorporation of the dye into the core sheet.

In embodiments that comprise a first coating and a second coating, these coatings can be applied separately or simultaneously. A variety of coating machines can be used to apply the first coating and/or the second coating, including: blade coaters, roll coaters, gravure coaters, curtain coaters and metering size press coaters. In some embodiments, the first coating and the second coating are applied with a blade coater and a roll coater, respectively. The blade coater and the roll coater can be part of a simultaneous two-sided coating application system, such as a two-stream coater. In other embodiments, the first coating and the second coating are applied at separate stations. The first coating and the second coating can be applied, for example, at from about 45% to about 68% solids, such as from about 55% to about 65% solids or from about 52% to about 62% solids.

The disclosed release papers and release-paper backings can be calendered. For example, the disclosed release papers and release-paper backings can be hot-soft calendered. In some embodiments, the release paper or release-paper backing is calendered in-line with two nips in a hot-soft calendering process. The calender rolls can be heated, for example, to between about 150° F. and about 400° F., such as between about 200° F. and about 300° F. The nips can be loaded, for example, at pressures between about 500 pli and about 2000 pli, such as between about 750 pli and about 1800 pli or between about 1000 pli and about 1500 pli.

### Properties of the Release-Papers and Release-Paper Backings

The disclosed release-paper backings generally have different properties than conventional release-paper backings, such as release-paper backings made from uncoated, supercalendered kraft paper. Table 1 shows values for various properties of a typical example of uncoated, supercalendered kraft paper.

TABLE 1
Properties of an Example of
Uncoated, Supercalendered Kraft Paper (Conventional)

| Property | Value |
|---|---|
| Basis Weight (lbs/1300 ft²) | 40.7 |
| Gurley Density | 14,000 |
| Smoothness (PPS-10) | 1.7 |
| Paper Gloss | 38 |
| b* Value | 4.8 |

The b* value represents blueness-yellowness in the L*a*b* color model developed by the International Commission on Illumination. All colors can be represented by this model. It is commonly used to represent color with a high degree of precision. Negative b* values indicate more blue than yellow. Positive b* values indicate more yellow than blue. As b* values increase, the degree of yellowness increases. The b* value can be measured with a spectrophotometer, such as a HunterLab LabScan spectrophotometer.

In contrast to supercalendered kraft paper, embodiments of the disclosed release papers and release-paper backings typically have a lower density. Some embodiments have a Gurley density between about 4,000 seconds and about 10,000 seconds, such as between about 4,000 seconds and about 8,000 seconds or between about 4,000 seconds and about 7,000 seconds. Conventionally, increased light transmission is achieved by increasing density. Increasing density, however, requires expensive processing, such as supercalendering. Embodiments of the disclosed release papers and release-paper backings also can have high density, but high density typically is not required in these embodiments to achieve acceptable light transmission. Therefore, to reduce manufacturing costs, many embodiments have lower density than conventional release papers and release-paper backings. Other features, such as dye, compensate for the lower density to provide these embodiments with acceptable light transmission.

Embodiments of the disclosed release papers and release-paper backings, particularly embodiments intended for use with red LED sensors, can have a higher b* value on the International Commission on Illumination L*a*b* scale than conventional release papers and release-paper backings. Some embodiments have a positive b* value, such as a b* value between about +6.0 and about +20, between about +8.0 and about +13, or between about +9.0 and about +11.0. The b* value can be adjusted, for example, by adjusting the amount and type of dye, such as the amount and type of yellow dye.

Some conventional high-density paper products, including some forms of glassine paper, have a somewhat yellow tint. This tint may be the natural result of various ingredients in the paper and may promote light transmission at certain wavelengths, such as wavelengths emitted by a red LED. Therefore, some disclosed embodiments are dyed to mimic the natural tint of certain high-density paper products.

The disclosed release papers and release-paper backings can be configured to have sufficient light transmission to allow operation of a through-beam LED sensor, such as a through-beam LED sensor incorporating an infrared, red, green, blue or white LED light source or a combination thereof As discussed above, typical red LED light sources emit light at wavelengths primarily in the range of about 660 nm to about 700 nm. The center of this range is about 680 nm. Some of the disclosed release papers and release-paper backings have light transmission at about 680 nm between about 40% and about 80%, such as between about 50% and about 80% or between about 52% and about 80%.

Some disclosed embodiments include a dye selected to improve light transmission at wavelengths generated by a particular type of LED light source, such as a red, green, blue or white LED light source or a combination thereof. As discussed above, yellow dye is particularly well-suited for increasing light transmission at wavelengths generated by red LED light sources. Yellow dye also can be used to increase light transmission at other wavelengths. Other colors of dye also can be used to increase light transmission at a variety of wavelengths, although they may have a more pronounced effect at some wavelengths than at other wavelengths.

### EXAMPLES

The following examples are provided to illustrate certain particular embodiments of the disclosure. Additional embodiments not limited to the particular features described are consistent with the following examples.

### Example 1

This example describes a constructed embodiment of a disclosed release-paper backing. This embodiment included a core sheet, a first coating and a second coating arranged in the configuration shown in FIG. 2.

The core sheet included bleached chemical pulps from the kraft pulping process, including both hardwood and softwood fiber types. Yellow dye was added to the core at about 1.9 ounces/ton. The yellow dye was CARTOSOL® Yellow 3GF supplied by Clariant Corporation (Muttenz, Switzerland).

The first coating included about 100 parts clay, about 5 parts starch, about 25 parts latex and about 1 part crosslinking agent. This first coating was applied such that the coating weights of the clay, starch, latex and crosslinking agent were about 5.0 lbs/3000 ft² (260 lbs/ton), about 0.25 lbs/3000 ft² (13 lbs/ton), about 1.2 lbs/3000 ft² (66 lbs/ton) and about 0.05 lbs/3000 ft² (2.7 lbs/ton), respectively. The total coating weight of the first coating was about 6.5 lbs/3000 ft² (340 lbs/ton). The clay was a combination of No. 2 coating clay and coarse delaminated clay in a ratio of about 70:30. The No. 2 coating clay HYDRASPERSE® supplied by J M Huber Corporation (Edison, N.J.). The coarse delaminated clay was NUSURF supplied by Engelhard (Iselin, N.J.). The starch was WESTCOTE 3080 modified potato starch supplied by Western Polymer (Moses Lake, Wash.). The latex was XU-30895.5 carboxylated styrene butadiene supplied by Dow Chemical (Midland, Mich.). The crosslinking agent was CURESAN® 199 modified glyoxal resin supplied by BASF (Ludwigshafen, Germany).

The second coating included a low molecular weight ethylated corn starch applied at about 16% solids. The coating weight of the second coating was about 1.0 lbs/3000 ft² (52.6 lbs/ton). The starch was PG 290 supplied by Penford Products (Englewood, Colo.).

Several measured properties of this constructed release-paper backing embodiment are shown in Table 2.

TABLE 2
Properties of Constructed
Release-Paper Backing Embodiment

| Property | Value |
|---|---|
| Basis Weight (lbs/1300 ft²) | 38.5 |
| Gurley Density | 6,500 |
| Smoothness (PPS-10 μm) | 3.0 |
| Paper Gloss | 25 |
| b* Value | 10 |

By way of comparison with the conventional release-paper backing of Table 1, this constructed release-paper backing had a much higher b* value and a much lower Gurley density.

### Example 2

This example describes the process that was used to make the release-paper backing described in Example 1. The bleached chemical pulps and yellow dye were mixed at the wet end of a Fourdrinier paper machine. After pressing and drying, the first and second coatings were applied by a blade coater and a roll applicator, respectively, in a simultaneous two-sided coating application system. The coated product then was calendered in-line with two nips of hot-soft calendering. The calender rolls were heated to between 200° F. and 250° F. and loaded to between 500 pli and 1000 pli.

### Example 3

This example describes the results of several light transmission tests conducted to determine the light transmission characteristics of certain embodiments of the disclosed release-paper backings. These tests were performed with a HunterLab UltraScan sphere spectrophotometer. The optical sensor on this device operated with diffuse illumination and an 8° angle. The test specimens were placed over the one inch diameter port for testing. External light was applied to each specimen. The transmitted light then was quantified by the device. Transmission data was collected across the visible spectrum (475 nm to 750 nm) for each sample.

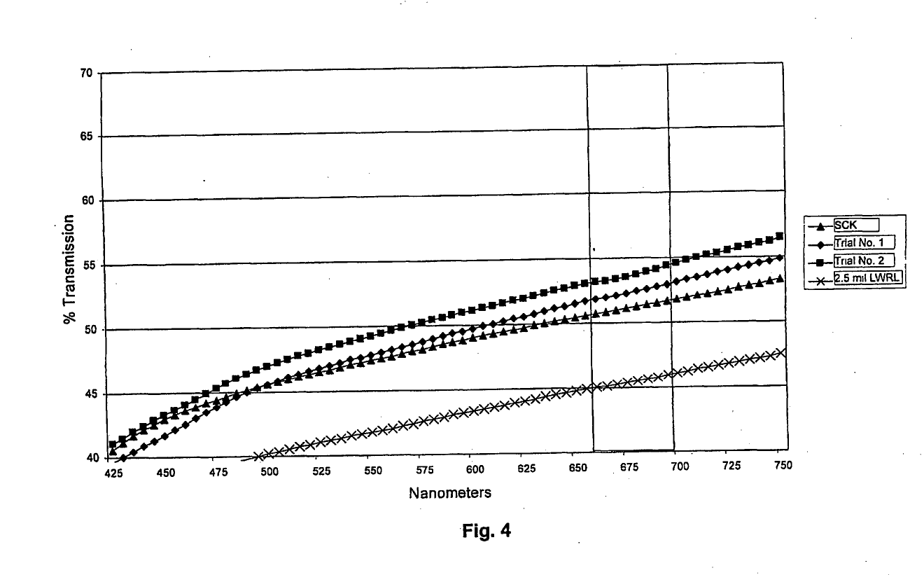

FIG. 4 shows the percent transmission across the visible spectrum for (1) uncoated, supercalendered kraft paper (SCK), (2) trial 1 release-paper backing, (3) trial 2 release-paper backing and (4) 2.5 mil lightweight release liner with no dye. The properties of the trial 1 release-paper backing, the trial 2 release-paper backing and the 2.5 mil lightweight release liner with no dye are shown in Table 3.

TABLE 3
Properties of Trial 1 Release-Paper Backing, Trial 2
Release-Paper Backing and 2.5 mil Lightweight Release Liner (LWRL)

| | | | 2.5 mil |
|---|---|---|---|
| Property | Trial 1 | Trial 2 | LWRL |
| Caliper (mm) | 2.35 | 2.45 | 2.5 |
| Opacity (%) by TAPPI Method T-425 | 63 | 63 | 67 |
| % Transmission at 680 nm | 52.6 | 53.7 | 45 |
| Gurley Density | 4,363 | 6,613 | 6,880 |
| L* Value | 93.60 | 93.50 | 92.20 |
| a* Value | −1.40 | −1.60 | −1.30 |
| b* Value | +10.00 | +11.60 | +3.30 |
| % Hardwood | 20 | 25 | 28 |
| % Softwood | 80 | 75 | 72 |
| Yellow Dye (ounces/ton) | 1.8 | 2.1 | 0 |
| Coat Weight (lbs/3000 ft²) | 6.8 | 7.0 | 6.8 |

The primary wavelength range emitted by a typical red LED light source (660 nm to 700 nm) is highlighted in FIG. 4. As shown in FIG. 4, increasing the b* value of the release-paper backing increases the light transmission across most of the visible spectrum, including the range of 660 nm to 700 nm. At a b* value of +10.00, the release-paper backing showed comparable light transmission to the supercalendered kraft paper. At a b* value of +11.60, the release-paper backing showed significantly greater light transmission than the supercalendered kraft paper

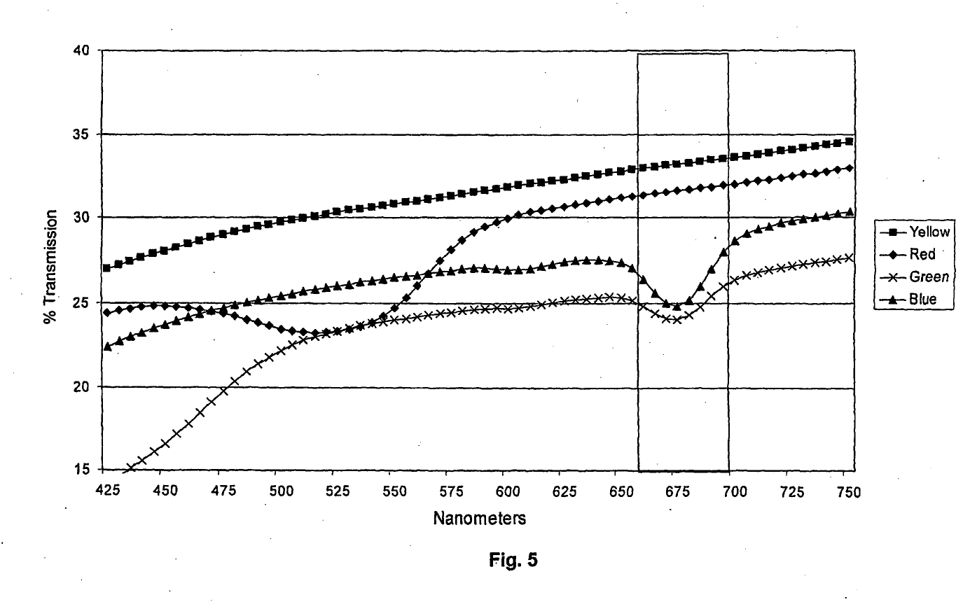

FIG. 5 shows the percent transmission for handsheets dyed four different colors (yellow, red, green and blue). The light transmission of the yellow handsheet was greater than the light transmission of the other handsheets at all wavelengths in the visible spectrum. The yellow handsheet also was the only handsheet that did not exhibit a pronounced dip in light transmission at any wavelengths in the visible spectrum. In contrast, the red, green and blue handsheets each exhibited a dip in light transmission at some portion of the visible spectrum. The dips for the green and blue handsheets occurred within the wavelength range emitted by a typical red LED.

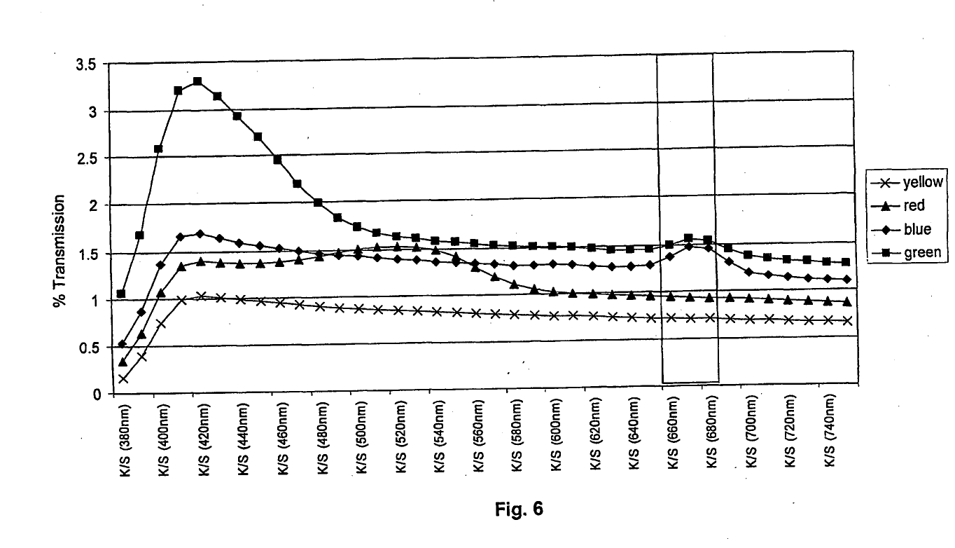

FIG. 6 shows the ratio of absorption (K) to scattering (S) for the same colored handsheets. Higher values for the K:S ratio correspond to greater opacity. As shown, the yellow handsheet had the lowest KS values at all wavelengths in the visible spectrum. Similar to FIG. 5, FIG. 6 shows that the K:S ratio for the yellow handsheet was more consistent over the visible spectrum, whereas the red, green and blue handsheets each exhibited increased K:S values at certain portions of the visible spectrum. For the green and blue handsheets, the increased K:S values occurred within the wavelength range emitted by a typical red LED.

The information in FIGS. 5 and 6 and other portions of this disclosure can be used to correlate particular dyes with their affect on light transmission at different wavelengths. For example, dyes can be selected based on FIG. 5 not to have a dip in light transmission at the wavelengths for which increased light transmission is desired.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A release-paper backing, comprising a network of fibers and a yellow and/or red dye, the release-paper backing having a light transmission between about 40% and about 80% at a wavelength of about 680 nm, and having at least one major surface configured to support a release coating.

2. The release-paper backing of claim 1, comprising a yellow dye.

3. The release-paper backing of claim 1, having a light transmission between about 50% and about 80% at a wavelength of about 680 nm.

4. The release-paper backing of claim 1, having a Gurley density between about 4,000 seconds and about 10,000 seconds.

5. (canceled)

6. The release-paper backing of claim 1, having a positive b* value on the International Commission on Illumination L*a*b* scale.

7. (canceled)

8. The release-paper backing of claim 1, wherein the yellow and/or red dye is distributed throughout the network of fibers.

9. The release-paper backing of claim 1, wherein the network of fibers is within a core sheet and further comprising a first coating on a first major surface of the core sheet and a second coating on a second major surface of the core sheet, wherein the first coating is configured to support the release coating, and the first coating comprises clay.

10. The release-paper backing of claim 9, wherein the first coating comprises between about 60% and about 80% clay.

11. The release-paper backing of claim 9, wherein the first coating further comprises starch, starch-like material, latex or a combination thereof.

12. The release-paper backing of claim 9, wherein the first coating further comprises starch or starch-like material and a crosslinking agent.

13. The release-paper backing of claim 9, wherein the second coating comprises starch and/or starch-like material and the starch and/or starch-like material substantially penetrates the core sheet to increase an ability of the release-paper backing to transmit light.

14-17. (canceled)

18. A release-paper backing, comprising:
a core sheet comprising a network of fibers;
a first coating positioned on a first major surface of the core sheet and configured to support a release coating; and
light transmission increasing means for increasing an ability of the core sheet, the first coating and any applied release coating to transmit light therethrough, the light transmission increasing means being added to or applied on the core sheet.

19. The release-paper backing of claim 18, having a light transmission between about 40% and about 80% at a wavelength of about 680 nm.

20. The release-paper backing of claim 18, having a Gurley density between about 4,000 seconds and about 10,000 seconds.

21. A release-paper backing, comprising:
a network of fibers; and
a dye configured to increase an ability of the release-paper backing to transmit light, wherein the release-paper backing has at least one major surface configured to support a release coating.

22. The release-paper backing of claim 21, wherein the dye is configured to increase the ability of the release-paper backing to transmit light generated by a red LED, a green LED, a blue LED, a white LED or a combination thereof.

23-39. (canceled)

40. A release paper, comprising:
a network of fibers;
a release coating; and
a dye configured to increase an ability of the release paper to transmit light, the dye having a dye color selected to increase transmittance through the release paper, wherein the dye color is selected based, at least in part, on a color of light to which the release paper is subjected during optical detection operations.

41. The release paper of claim 40, wherein the dye is configured to increase the ability of the release paper to transmit light generated by a red LED, a green LED, a blue LED, a white LED or a combination thereof.

42. A method for making a release paper or release-paper backing, comprising:
forming a mixture comprising a paper stock and a dye selected to increase the light transmission of the release paper or release-paper backing at a wavelength range generated by a red LED, a green LED, a blue LED, a white LED or a combination thereof;
forming the mixture into a sheet;
applying a coating to a major surface of the sheet; and
hot-soft calendering the sheet.

43. The method of claim 42, wherein the coating is a first coating and further comprising applying a release coating over the first coating.

44. The method of claim 42, wherein the coating is a first coating, the major surface is a first major surface, and further comprising applying a second coating on a second major surface of the sheet, wherein the second coating comprises a starch or starch-like material and the starch or starch-like material substantially penetrates into the sheet.

45. The method of claim 42, wherein hot-soft calendering comprises calendering at a pressure between about 500 pli and about 2000 pli.

46. The method of claim 42, wherein hot-soft calendering comprises hot-soft calendering to achieve a Gurley density between about 4,000 seconds and about 10,000 seconds.

47-52. (canceled)
